(19) United States
(12) Patent Application Publication
(10) Pub. No.: US 2020/0178582 A1
(43) Pub. Date: Jun. 11, 2020

(54) Reduced Water Activity Date Composition

(71) Applicant: General Mills, Inc., Minneapolis, MN (US)

(72) Inventors: Jill A Conley, Shakopee, MN (US); Jeffrey F Enz, Minneapolis, MN (US); Andrea Klostermann, Wyoming, MN (US); Philippe A Vandweghe, Plymouth, MN (US)

(73) Assignee: General Mills, Inc., Minneapolis, MN (US)

(21) Appl. No.: 16/211,575

(22) Filed: Dec. 6, 2018

(51) Int. Cl. A23L 19/00; A23L 29/238

(52) U.S. Cl. CPC A23L 19/09; A23L 29/238; A23V 2200/14; A23V 2250/21; A23V 2002/00

(57) ABSTRACT

Described are food compositions that include a fruit paste, a dried fruit, and a nut butter. The food compositions have a lower water activity (less than 0.6) than similar fruit paste-based food compositions that do not include a dried fruit, while retaining a desired texture and moisture perception. Also described are methods of making the described food compositions, and food products including the described food compositions.

### BACKGROUND OF THE INVENTION

Consumers are increasingly looking for new and interesting eating experiences. Consumers also expect foods with fewer and/or simpler ingredients, while still retaining the convenience of shelf-stability. Fruit paste-based food products, such as Larabar™ and Larabar™ Bites are examples of snacks that provide an enjoyable eating experience while also containing simple ingredients. Due to the high fruit paste content of such product, they tend to have relatively high water activity. High water activity tends to increase the risk of microbial growth over shelf life. Although microbial growth is typically not harmful, it can negatively impact the eating experience of the product by consumers. Although water activity can be controlled using ingredients, such as glycerol or sugar, consumers that prefer simple foods also prefer that those ingredients not be included in the products they enjoy. Thus, a new challenge has been to produce foods that fulfill the need for enjoyable, shelf stable foods, while using simple ingredients.

### SUMMARY

A food composition is provided herein. The food composition has a water activity (Aw) of less than 0.6, and includes a fruit paste in an amount of at least 25% by weight of the composition, dried fruit particles having a particle size less than ¼ inch mesh, where the dried fruit particles are included in the food composition at a ratio of between 1:1.5 and 1:5 by weight dried fruit particles to the amount of fruit paste by weight, and a nut butter in an amount of up to 30% by weight of the composition.

In some embodiments, the dried fruit particle size can be between ¼ inch mesh and No. 8 mesh, or between No. 5 mesh and No. 7 mesh.

In some embodiments, the dried fruit particles can include dried apple particles or dried pear particles.

In some embodiments, a food composition provided herein can include an oil.

A packaged food product is also provided herein. The packaged food product includes a food composition having a water activity of less than 0.6, where food composition includes a fruit paste in an amount of at least 25% by weight of the composition, dried fruit particles having a particle size less than ¼ inch mesh, where the dried fruit particles are included in the food composition at a ratio of between 1:1.5 and 1:5 by weight dried fruit particles to the amount of fruit paste by weight, and a nut butter in an amount of up to 30% by weight of the composition.

In some embodiments of a packaged food product, the dried fruit particle size can be between ¼ inch mesh and No. 8 mesh, or between No. 5 mesh and No. 7 mesh.

In some embodiments of a packaged food product, the dried fruit particles can include dried apple or dried pear particles.

In some embodiments of a packaged food product, the food composition can include an oil.

In some embodiments of a packaged food product, the food composition can be formed into a snack bar or a disk.

In some embodiments of a packaged food product, the packaged food product can have a shelf life of at least 6 months.

A method of making a food composition is also provided herein. A method of making a food composition includes combining dried fruit particles having an Aw of less than 0.6 and a particle size less than ¼ inch mesh with a fruit paste having an Aw of 0.6 to 0.7 and a nut butter, the dried fruit particles and fruit paste combined at a ratio of between 1:1.5 and 1:5 dried fruit particles by weight to fruit paste by weight to produce the food composition having a water activity of less than 0.6.

In some embodiments of a method provided herein, the dried fruit particle size can be between ¼ inch mesh and No. 8 mesh, or between No. 5 mesh to No. 7 mesh.

In some embodiments of a method provided herein, the dried fruit particles can have an Aw of 0.40 to about 0.55.

In some embodiments of a method provided herein, the method can include a step of rehydrating the dried fruit particles if they have an Aw of less than 0.4 to achieve an Aw of 0.40 to about 0.55 of the dried fruit particles.

In some embodiments of a method provided herein, the dried fruit particles can include dried apple or dried pear particles.

In some embodiments of a method provided herein, the nut butter can be included in an amount of up to 30% by weight of the composition.

In some embodiments, a method provided herein can further include a step of forming the food composition into pieces. In some embodiments, the pieces can be formed into snack bars, disks, or bites.

In some embodiments, a method provided herein can further include a step of packaging the food composition.

Additional objects, features, and advantages of the invention will become more readily apparent from the following detailed description when taken in conjunction with the drawings wherein like reference numerals refer to corresponding parts in the several views.

### DETAILED DESCRIPTION

Fruit paste-based food products, such as Larabar™ and Larabar™ Bites are examples of fruit paste-based snacks that consumers recognize as foods having simple ingredients. Consumers particularly enjoy an eating experience from these food products that exhibits a moist, homogenous texture perception and enjoyable flavors. The high fruit paste content of such products increases the risk of microbial growth over shelf life, however. The present disclosure describes a solution for reducing water activity (A_{w}) without relying on more complex or refined ingredients, such as glycerol or sugar, and without negatively impacting the familiar texture and flavors of the original food product.

During reformulation of a fruit paste-based food product to improve shelf stability, it was discovered and is disclosed herein, that including dried fruit particles of a particular size range and at a particular ratio relative to the fruit paste, in combination with a nut butter, provided sufficiently low water activity (less than 0.6) to reduce the risk of microbial growth while providing an eating experience that resembled the original product, which didn't include dried fruit particles. Thus, a food product disclosed herein has a previously unavailable combination of benefits of increased shelf stability of a known product and ingredients that satisfy consumer expectations for ingredient simplicity, mouthfeel, and flavor of the known product.

In some embodiments, a food product provided herein can be evaluated by a panel of at least 100 (e.g., at least 120) tasters on the basis of texture liking, flavor liking, and overall liking to determine whether the product resembles an original product (e.g., Larabar™ brand snack bars). Texture liking, flavor liking, and overall liking can be evaluated on a scale of 1 to 9, with a score of 1 meaning that the taster disliked the food product very much, and a score of 9 meaning that the taster liked the food product very much. A score difference between the food product and the original product that is not statistically significant (p<0.001) indicates parity in liking.

In some embodiments, hardness of a food product provided herein can be evaluated by a panel of at least 9 tasters trained in Sensory Spectrum Descriptive Analysis method (M. C. Meilgaard, G. V. Civille, and B. T. Carr (Eds.). (2015). Sensory Evaluation Techniques. 5^{th} Edition. CRC Press, LLC). Hardness refers to the force required to compress through the product upon first bite with the incisors or first chew with the molars, and is evaluated according to the Standard Hardness Scale found in Chapter 12 of the 5^{th} Edition of “Sensory Evaluation Techniques.”

A food composition provided herein includes a fruit paste (e.g., date paste, apricot paste, or fig paste) in an amount of at least 25% (e.g., from about 25% to about 50%, or from about 27% to about 40%) by weight of the composition. Fruit pastes suitable for use herein include fruit pastes having an A_{w} of at least 0.6 (e.g., 0.6 to about 0.73, or 0.6 to about 0.65).

A food composition provided herein also includes dried fruit particles. Dried fruit particles in a particular ratio relative to fruit paste and of a particular size range can reduce A_{w} (e.g. from at least 0.6 to less than 0.6). Although the inclusion of dried fruit pieces can reduce a perception of lubricity in mouthfeel, including dried fruit pieces with a nut butter can provide a mouthfeel that is perceived as similar, or in some embodiments improved, relative to a formulation of the food composition lacking the dried fruit particles. Importantly, a dried fruit included as described in a food composition provided herein does not significantly change the flavor to resemble the dried fruit. That is, although the flavor of a dried fruit in a food composition may be perceived by consumers, it is generally not perceived as a primary flavor of the food composition, and does not overwhelm other expected flavors in the food product.

Dried fruit particles are included in a food composition at a ratio of dried fruit particles to fruit paste of from 1:1.2 to 1:6 (e.g., about 1:1.5 to about 1:5, or about 1:1.6 to about 1:4) on a weight basis. In some embodiments, the amount of dried fruit particles included in a food composition can range from about 4% to about 45% (e.g., from about 5% to about 35%, or about 8% to about 25%) by weight of the food composition. In some embodiments, the amount of fruit paste plus dried fruit particles can make up at least 35% (e.g., from about 35% to about 60%, or about 38% to about 55%) by weight of a food composition provided herein.

Dried fruit particles suitable for use in a food composition provided herein have a particle size of less than ¼ inch mesh. In some embodiments, dried fruit particles suitable for use in a food composition provided herein have a particle size between ¼ inch mesh and No. 8 mesh (e.g., between No. 5 mesh and No. 7 mesh). In some embodiments, dried fruit particles suitable for use herein can be a powder. As used herein, particles having a particle size being less than a given mesh size indicates that at least 98% (e.g., at least 99%) of the particles will pass through a mesh of the given mesh size. As used herein, particles having a particle size being between two given mesh sizes indicates that at least 98% (e.g., at least 99%) of the particles will pass through the larger mesh size and be retained on the smaller mesh size. Larger dried fruit particles can introduce a perceived heterogeneity in the texture of the product. Perceived heterogeneity in a food composition provided herein is generally undesired because it can increase the detection of dried fruit particles as a new or unfamiliar ingredient. In some cases, larger dried fruit particles in a food composition provided herein can undesirably increase the perception of the flavor of the dried fruit particles in the food composition. In some cases, dried fruit particles smaller than No. 8 mesh can produce a harder product even when achieving the same overall Aw as with particles between No. 8 mesh and ¼ inch mesh.

As used herein, a dried fruit suitable for use as dried fruit particles includes any fruit or vegetable having an A_{w} of less than 0.6 (e.g., from about 0.40 to about 0.55, or from about 0.45 to about 0.55). In some embodiments, dried fruit particles having an A_{w} of less than 0.4 can be rehydrated to achieve an A_{w} of 0.40 to 0.55 (e.g., 0.45 to 0.55) prior to being included in a food product provided herein. Rehydration of dried fruit particles can be performed prior to combining the dried fruit particles with a fruit paste or other ingredients, or can be done at the same time as combining the dried fruit particles with a fruit paste or other ingredients.

In some embodiments, dried fruit particles can have a sugar content with a sucrose to fructose ratio of less than 1 (e.g., from about 0.05 to 0.8, about 0.2 to about 0.6, or from about 0.3 to about 0.5).

Examples of dried fruits suited for use in a food composition provided herein include dried apples, dried pears, dried squash, raisins, dried sweet potatoes, prunes, dried cranberries, and the like. Dried pome fruit, such as dried apples and dried pears are particularly suitable for use in a food composition provided herein.

A food composition provided herein includes a nut butter in an amount of up to 30% (e.g., from about 5% to about 25%, or from about 8% to about 25%) by weight of the composition. In some embodiments, the amount of fruit paste plus dried fruit particles plus nut butter can make up at least 50% (e.g., from about 50% to about 80%, or from about 52% to about 75%) by weight of a food composition provided herein. A nut butter included in a food composition provided herein can increase lubricity in the mouthfeel of the food composition. Increased lubricity from a nut butter in a composition containing a dried fruit can increase moisture perception by consumers, even though the water activity is reduced relative to a formulation that lacks dried fruit.

Any edible nut butter can be used in a food composition, including without limitation, peanut butter, cashew butter, hazelnut butter, almond butter, or the like, or combinations thereof. As used herein, a nut butter refers to a semi-solid paste made from ground nuts (e.g., tree nuts, peanuts, and the like). In some embodiments, a nut butter provided herein contains only ingredients made from ground nuts, and, optionally, salt.

Additional ingredients can be included in a food composition provided herein in an amount of up to 50% (e.g., up to 45%) by weight of the food composition. Examples of additional ingredients can include, without limitation, oil (e.g., peanut oil, olive oil, almond oil, canola oil, or the like), chocolate, cocoa powder, nuts or nut pieces, flavor extracts (e.g., vanilla, mint, or the like), or other fruit or vegetable ingredients (e.g., fruit or vegetable juice, squash puree, dried herbs, or the like), or mixtures thereof. For example, an oil can be included in an amount of up to 6% (e.g., about 3% to about 5%) by weight of a food composition. In another example, chocolate pieces can be included in an amount of up to 35% (e.g., 20% to 30%) by weight of a food composition.

Weight basis of ingredients in a food product provided herein is based on the weights of the ingredients prior to combination. It is to be understood that moisture from one or more ingredients can migrate to other ingredients following combination and affect the weight of individual ingredients.

A food composition can be made using any appropriate method and equipment. For example, food composition ingredients provided herein can be combined in a batch mixer, or a continuous mixer, or an extruder. Ingredients can be added at once, or in any order. As discussed above, if dried fruit particles are rehydrated to a desired A_{w}, they can be rehydrated before or after combining with one or more additional ingredients.

A food composition can be formed into pieces in any desired shape, such as a snack bar, snack bites, sheets, strips, or disks. For example, a food composition can be cut upon exiting an extruder. In another example, a food composition can be rolled or pressed into a layer and cut into pieces. In another example, portions of a food composition can be rolled into balls using, for example, the methods and equipment disclosed in WO2017/172413.

In some embodiments, food composition pieces can have a dry coating, such as carob powder, cocoa powder, powdered sugar, a starch, a nut flour, or any combination thereof, applied to one or more surface of the pieces. In some embodiments, a food product can be portioned into pieces that are from about 5 g to about 10 g (e.g., from about 6 g to about 9 g, or about 7 g to about 8 g).

A food composition provided herein can be packaged using any appropriate packaging to produce a food product. For example, a food composition provided herein can be packaged as multiple bite-sized pieces in a bag, or individually wrapped as snack bars. A food product provided herein can have a shelf life of at least 6 months (e.g., at least 8 months, or at least 12 months) at room temperature.

### EXAMPLES

### Example 1

Date paste-based bars were made according to Table 1. Samples A1, B1, and C1 were controls with an A_{w} of about 0.65. The remaining samples in Table 1 were made using dried apple particles (⅛ inch average size) to produce bars having an A_{w} of about 0.59, dried pear particles (8 mesh flakes) to produce bars having an A_{w} of about 0.58, or dried date particles (powder) to produce bars having an A_{w} of about 0.60.

TABLE 1

| Sam- | | Dried fruit:date paste | Nut butter (% by |
|---|---|---|---|
| ple | Description | (formula wt %:wt %) | formula weight) |
| A1 | Control A, cashew | NA | 0% |
| | cookie flavor | | |
| A2 | Variation of A1, | 1:2.1 | 8-10% |
| | using dried apple | | |
| A3 | Variation of A1, | 1:3.8 | 8-10% |
| | using dried pear | | |
| A4 | Variation of A1, | 1:2.1 | 8-10% |
| | using dried date | | |
| B1 | Control B, blueberry | NA | 0% |
| | muffin flavor | | |
| B2 | Variation of B1, | 1:1.6 | 8-10% |
| | using dried apple | | |
| B3 | Variation of B1, | 1:4.2 | 8-10% |
| | using dried pear | | |
| B4 | Variation of B1, | 1:2.0 | 8-10% |
| | using dried date | | |
| C1 | Control C, chocolate | NA | 0% |
| | chip cookie dough | | |
| | flavor | | |
| C2 | Variation of C1, | 1:1.4 | 10% |
| | using dried apple | | |
| C3 | Variation of C1, | 1:3.1 | 10% |
| | using dried pear | | |
| C4 | Variation of C1, | 1:1.4 | 10% |
| | using dried date | | |

Each sample was presented to an untrained panel of 121 tasters, who were selected on the basis of consuming Larabar™ brand snack bars at least once a week, and consider Larabar™ brand snack bars to be a top 3 favorite snack. The tasters were asked to provide their flavor liking, texture liking, and overall liking of each of the samples on a scale of 1-9.

Analysis of the results of the tasting panel show that for the cashew cookie flavor and blueberry muffin flavor, the samples with the dried apple particles had a flavor liking, texture liking, and overall liking achieving parity or higher with the control. For the chocolate chip cookie dough flavor, the samples including dried apple particles had a flavor liking, texture liking, and overall liking slightly lower than the control.

For the samples containing dried pear particles, the cashew cookie flavor and blueberry muffin flavor had average scores in flavor liking and overall liking achieving that were at parity with the control. The texture liking on these samples were slightly lower than control. For the chocolate chip cookie dough flavor, the flavor liking and overall liking were slightly lower than the control, while the texture liking was much lower than control.

For the samples containing dried date particles, the cashew cookie flavor and blueberry muffin flavor had average scores for flavor liking, texture liking, and overall liking slightly lower than control, while the scores for the chocolate chip cookie dough were much lower than control.

Overall, the results suggest that larger dried fruit particle size is more preferred, but that smaller particle size can achieve good results.

### Example 2

Date paste-based bars were made according to Table 2. Sample 1 was a control with an A_{w} of 0.65. Samples 2-4 each included dried apple particles in different particle sizes in sufficient quantity to achieve an A_{w} of 0.60 to 0.62.

TABLE 2

| | Dried apple | Dried fruit:date paste | Nut butter (% by |
|---|---|---|---|
| Sample | particle size | (formula wt %:wt %) | formula weight) |
| 1 | None | NA | 0% |
| 2 | ⅛ inch | 1:2.1 | 8% |
| 3 | 8 Mesh | 1:3.6 | 8% |
| 4 | 20 Mesh | 1:3.6 | 8% |

Each sample in Table 2 was presented to a panel of 9 trained tasters, who evaluated a number of different texture and flavor aspects, including hardness. Hardness was measured as described above. The results showed that the hardness perception of Sample 2 was not statistically significantly different from Control (Sample 1), while both Sample 3 and Sample 4 were statistically significantly harder than Control. Additional experimentation showed that some of the hardness differences in the samples using smaller dried fruit particle sizes could be ameliorated by moistening the particles to an A_{w} of 0.4 to 0.55.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A food composition, the food composition having a water activity (A_{w}) of less than 0.6, and comprising a fruit paste in an amount of at least 25% by weight of the composition, dried fruit particles having a particle size less than ¼ inch mesh, wherein the dried fruit particles are included in the food composition at a ratio of between 1:1.5 and 1:5 by weight dried fruit particles to the amount of fruit paste by weight, and a nut butter in an amount of up to 30% by weight of the composition.

2. The food composition of claim 1, wherein the dried fruit particle size is between ¼ inch mesh and No. 8 mesh.

3. The food composition of claim 1, wherein the dried fruit particle size is between No. 5 mesh and No. 7 mesh.

4. The food composition of claim 1, wherein the dried fruit particles comprise dried apple or dried pear particles.

5. The food composition of claim 1, further comprising an oil.

6. A packaged food product, comprising a food composition having a water activity of less than 0.6, the food composition including a fruit paste in an amount of at least 25% by weight of the composition, dried fruit particles having a particle size less than ¼ inch mesh, wherein the dried fruit particles are included in the food composition at a ratio of between 1:1.5 and 1:5 by weight dried fruit particles to the amount of fruit paste by weight, and a nut butter in an amount of up to 30% by weight of the composition.

7. The packaged food product of claim 6, wherein the dried fruit particle size is between ¼ inch mesh and No. 8 mesh.

8. The packaged food product of claim 6, wherein the dried fruit particle size is between No. 5 mesh and No. 7 mesh.

9. The packaged food product of claim 6, wherein the dried fruit particles comprise dried apple or dried pear particles.

10. The packaged food product of claim 6, wherein the food composition further comprises an oil.

11. The packaged food product of claim 6, wherein the food composition is formed into a snack bar.

12. The packaged food product of claim 6, wherein the food composition is formed into a disk.

13. The packaged food product of claim 6, wherein the food product has a shelf life of at least 6 months.

14. A method of making a food composition, comprising combining dried fruit particles having an A_{w} of less than 0.6 and a particle size less than ¼ inch mesh with a fruit paste having an A_{w} of 0.6 to 0.7 and a nut butter, the dried fruit particles and fruit paste combined at a ratio of between 1:1.5 and 1:5 dried fruit particles by weight to fruit paste by weight to produce the food composition having a water activity of less than 0.6.

15. The method of claim 14, wherein the dried fruit particle size is between ¼ inch mesh and No. 8 mesh.

16. The method of claim 14, wherein the dried fruit particle size is from No. 5 mesh to No. 7 mesh.

17. The method of claim 14, wherein the dried fruit particles have an A_{w} of 0.40 to about 0.55.

18. The method of claim 14, further comprising a step of rehydrating the dried fruit particles if they have an A_{w} of less than 0.4 to achieve an A_{w} of 0.40 to about 0.55 of the dried fruit particles.

19. The method of claim 14, wherein the dried fruit particles comprise dried apple or dried pear particles.

20. The method of claim 16, wherein the nut butter is included in an amount of up to 30% by weight of the composition.

21. The method of claim 14, further comprising forming the food composition into pieces.

22. The method of claim 19, wherein the pieces are formed into snack bars, disks, or bites.

23. The method of claim 14, further comprising packaging the food composition.
